(19) United States
(12) Patent Application Publication
(10) Pub. No.: US 2001/0050673 A1
(43) Pub. Date: Dec. 13, 2001

(54) Ergonomic fingertip computer mouse

(76) Inventor: Anthony G. Davenport, Berkeley, CA (US)

Correspondence Address: Howard Cohen, 1105 THE ALAMEDA, BERKELEY, CA, 94707-2501, US

(21) Appl. No.: 09/756,024

(22) Filed: Jan. 8, 2001

Related U.S. Application Data
(60) Provisional application No. 60/182,150, filed on Feb. 14, 2000.

(51) Int. Cl. G09G 5/08

(52) U.S. Cl. 345/163

(57) ABSTRACT

A computer mouse includes a gliding base and a side wall extending upwardly therefrom in a closed, curved shape such as a cylinder. The cylinder width is dimensioned to be grasped between the thumb and opposed fingers of the hand. A concave grip extends about the side wall, the concavity complementary to the curved fingertip surfaces grasping the mouse. Switches are located in the grip under the grasping fingers, so that “click” inputs are made without moving the grasping fingers. Additional switches may be placed in the dome-like top panel spanning the upper opening of the side wall. One switch may provide a clutch function to block screen cursor movement while the mouse is slidably returned to a convenient user position. The mouse cable exits from the top panel to define a slack loop that minimizes drag on the mouse.

### REFERENCE TO RELATED APPLICATION

This application claims priority based on Provisional Patent Application Ser. No. 60/182,150, filed 02/14/2000.

### BACKGROUND OF THE INVENTION

Since computers have been introduced to the general population and workforce in the 70's, human input to computer has been achieved with the combined use of a keyboard and pointing device or mouse. Except where specialized precision needs have created divergent mouse designs, (i.e. drawing pens and trackballs) the original hand-held desk top mouse survives with little more than sculptural improvement. At the same time we find that the burgeoning, application-intensive use of these devices in the workplace has resulted in an industry wide problem of operator injury, such as CTS. Innovation in the prior art frequently focuses on the need to improve the ergonomics of the mouse, given its poor track record and its continually expanding use in the workplace. The term “hand-held mouse” is used herein to refer to the vast field of desktop mice for which the hand as well as fingers was meant to move and rest upon. In contrast, the term “fingertip mouse” is used herein to refer to the present invention in which only the fingertips grasp or touch the mouse. There are four mouse design and application issues which recommend the new approach embodied in the present invention.

1. Hand-held computer mouse innovation builds upon a fundamentally non-ergonomic design. Initially, the mouse was conceived to generate non-continuous and occasional signals for control and selection purposes relative to programs that were mainly keyboard driven. Early mice were sized for the hand and shaped to hold the mechanical and electronic components needed to produce the desired electrical signals. Ergonomic issues were not considered critical in design because mouse use as such was not seen as physiologically demanding. The mouse was conceived as a hand-sized box of control buttons and motion processing hardware to be pushed about a desktop by a human hand with a minimum of effort or skill, in order to generate a set of electronic signals, themselves having neither size nor weight. Present technology, as demonstrated in the fingertip mouse, allows for a significantly smaller mouse form and affords greater mouse precision that accommodates decreased mouse movement. Together these factors provide a reduced ergonomic intensive interface.

2. Hand-held mice are actually moved by the arm, which proves to be injurious. A review of RSI (repetitive stress injury) studies show irrefutably that the joints and muscular system of the shoulder, elbow, forearm and wrist operate under stress and are prone to injury when used to accomplish repetitive mouse movement. The position of the hand while resting on these devices usually places the wrist either flat on the desktop or upon a wrist pad, as shown in FIG. 1, and both positions cause compression of the carpal tunnel, one of the primary contributing factors to CTS.

3. New computer applications such as gaming make even greater demands of mouse motility that the hand-held mouse can not perform satisfactorily. During computer game play, the mouse is in constant and continuous use which makes design goals like “relaxed position” and “position of repose” less achievable. Current gaming applications are capable of deriving a motion or angle vector from mouse input, making it highly desirable to be able to impart “spin” to, or rotate, the mouse. However, the relatively coarse control of the deltoid muscle group that rotates the elbow to achieve this makes it an ergonomically difficult task.

The hand-held mouse makes little use of the human hand's most dexterous and sensitive control architecture: the thumb and opposable finger group. The feedback transmitted tactilely through the object oppositionally grasped allows control of sophisticated motion in that the object may be effectively moved simultaneously in different directions at either contact point. The high degree of control that is obtained from this tactile feedback loop makes possible the surgeon's scalpel, the scientist's dial, and the violinist's bow. It is appropriate, in light of the current ergonomic shortcomings to regard mouse control as a similarly challenging operation that should maximally utilize and conserve the hand's strength and dexterity. Designs providing for a more relaxed position or “state of repose” for the hand may continue the original assumption of mouse control as a non-skilled non-task.

### SUMMARY OF THE INVENTION

The present invention generally comprises a fingertip mouse that fits within the hand and is held oppositionally between the thumb and either index, middle, or ring finger where it may be rotated and moved by complex independent motions of either or both grasping digits. These motions are vectored upon whatever motion may be imparted to the hand by the forearm and shoulder, which this design does not eliminate, but renders redundant. Thus the fingertip grasp provides a control redundancy that a skilled operator may employ to alternately rest the musculature imparting movement to the mouse. The hand rests upon the desktop rather than upon the fingertip mouse, and obtains continuous support along the lateral side (the “blade” of the hand) from the heel to the tip of the little finger. The wrist is rotated upward in this position such that the carpal tunnel is elevated, and consequently relieved of compression. The posture is natural and familiar, reminiscent of handwriting, and the little finger, curled comfortably upon the desktop, provides an independently adjustable stability. Thus this design provides for the hand to be supported by or rest upon the desktop, not the mouse structure itself.

The small travel radius of the mouse, (approx. ½ diameter) enabled by software mouse sensitivity settings, allows the thumb/opposable finger to contain and produce virtually all the movement. The heel of the hand may then remain relaxed and motionless for most operations, eliminating any need for shoulder or elbow movement.

There are several aspects of the invention that lead to its superior ergonomic performance:

Size: The fingertip mouse is sized so that it may be held comfortably between the thumb and middle finger of the human hand. A diameter of 2″-2.5″ accommodates a range of hand sizes while allowing space for switch access aligned with the curve of the index finger.

Shape: The optimal shape for the oppositionally grasped mouse is circular, allowing the mouse to be rocked or smoothly rotated between the two contact points.

Weight: The weight of the mouse is designed to be within the exercise range of the musculature of the control digits. Testing shows that a weight of between 65-80 grams can be used comfortably over extended sessions by adult users. This is approximately one-half the weight of the average hand-held mouse.

Vertical grasping surface: An optimal grasping surface is afforded by a continuous curved side wall forming a vertical surface contoured by a soft tactilely responsive grip material molded with a slight concavity to accommodate the radius of the fingertips in a comfortable and secure manner.

Skirt: A thin (2mm) skirt which continues the bottom plane of the mouse radially to a maximum diameter of 80-85 mm, provides the small, low mass mouse with a stable base. The natural weight of the fingers upon the skirt steadies the mouse, eliminates tipping and prevents inadvertent fingertip drag upon the desktop surface.

Off-board controller: In order to achieve the small cross-sectional size suitable for comfortable grasp by the thumb and middle finger, the mouse controller chip and card, typically housed within the hand-held mouse, may be moved down the mouse cord where it may be housed in any variant of an in-line assembly such as a desktop USB hub or connection box, or simple encapsulation. The mouse contains only the switches, mechanical motion tracking mechanism, and encoder stage necessary to produce the electrical signal input to the processor. The controller assembly is distanced 12″ or more to permit unimpeded motion of the mouse connected via a flexible shielded cable that attaches to the top surface of the mouse to reduce drag.

Encoder Wheel Masks: This invention utilizes finely windowed encoder wheel masks to input motion control pulses to the processor. These masks are made of circular disks of film (acetate, Mylar™, or the like) that are rotated by the encoder shafts, on which disks the light/dark masking is photographically printed, The photographic printing of the encoder mask on the films allows an alternative method to current technology (holes stamped in the plastic encoder wheel) for achieving fine mask reticules. The high resolution of these encoder wheel masks facilitates high sensitivity mouse settings that enable fingertip mouse motions to span a computer screen with high accuracy.

Operating buttons: The fingertip mouse may be provided with two sets of mouse buttons. The switches are electrically connected in parallel so that both sets are operable. One set comprises one or more membrane switches secured to the closed curved vertical side wall of the mouse and positioned so that the grasping fingers of the user's hand may actuate the one or more switch without moving from the grasping position. This feature enables the fastest reaction time (for gaming purposes) and the least muscular movement (for ergonomic purposes). A second set of switches comprises one or more switches supported in the top wall of the mouse and accessible by the index and second finger of the user's hand, for those users who are more comfortable with the familiar top-mounted mouse buttons, such as left-click and right-click.

The skirt described above functions to increase front-to-back stability while moving the mouse, and is not essential if appropriate stability of the mouse may be achieved by design of the mouse body and tracking mechanism alone, although there is some utility in the radial markings which may be marked on the clear skirt, in that they are useful as a reference for drawings arcs and plotting within CAD and navigational charting applications

While the redundancy of the two mouse button sets is a desirable feature achieved within the invention, it is not essential, and either one or the other (top or side) switch sets (or some partial set of both) would be sufficient to achieve the operation of the mouse. The mouse button aspect of the invention is not limited to membrane switches and may be achieved by another switch type as well (i.e., micro switches). Nor is the number of buttons critical to the design and any combination of switches could be effectively be used in the invention. While the inclusion of all the electrical control components necessary to the mouse is constrained by the size, weight, and shape aspects of the invention, it may be achieved with current technology by using sufficiently small components. Thus the offboard controller aspect is seen as but one alternative way to effect the design of the fingertip mouse. Similarly, while the mouse is described utilizing a trackball motion encoder, any other tracking technology, such as optical sensing, magnetic sensing, or other mechanical tracking arrangements, may be used with the invention.

### BRIEF DESCRIPTION OF THE DRAWINGS

FIG. 1 is a perspective view of a typical prior art computer mouse.

FIG. 2 is a cross-sectional elevation of the computer mouse of the present invention.

FIG. 3 is a top view of the computer mouse depicted in FIG. 2.

FIG. 4 is a perspective elevation showing the computer mouse of FIGS. 2 and 3 wielded by the hand of a user.

FIG. 5 is a top view showing the computer mouse of FIGS. 2-4 wielded by the hand of a user.

FIG. 6 is a perspective elevation showing the computer mouse of FIGS. 2-5, including a top mounted switch actuated by the user.

FIG. 7 is a cross-sectional detailed elevation showing the top mounted switch of the computer mouse of the invention.

FIG. 8 is a cross-sectional detailed elevation showing the side mounted switch of the computer mouse of the invention. FIG. 9 is a bottom view of the computer mouse of FIGS. 1-8.

FIG. 10 is a partial cross-sectional elevation showing a further embodiment of the top switch of the computer mouse of the invention.

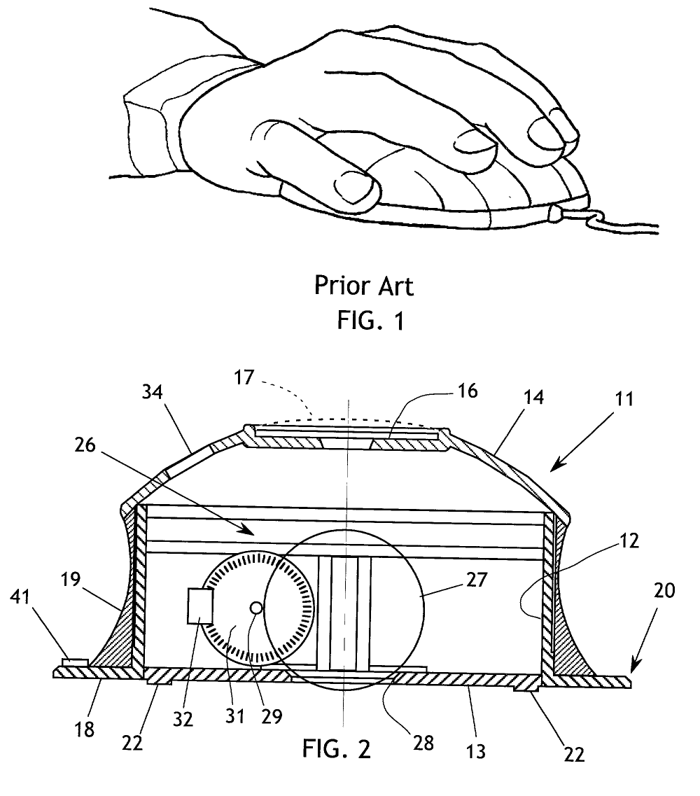

### DESCRIPTION OF THE PREFERRED EMBODIMENT

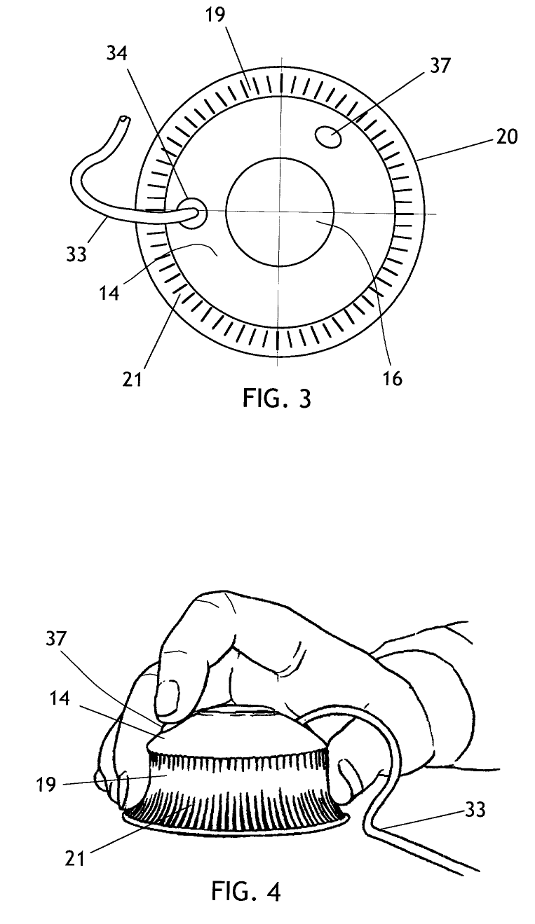

The present invention generally comprises a computer mouse device that provides enhanced ergonomic, mechanical, and electronic features. With regard to FIGS. 2 and 3, one embodiment of the invention that exemplifies these features comprises a mouse assembly 11 having a closed curved side wall 12 extending upwardly from a base panel 13 that spans the side wall 12 to define an enclosed bottom opening. A top panel 14 extends across the upper opening of the side wall 12 to enclose the top opening thereof, the top panel having the same general closed curved configuration as the side wall 12. The top panel may be provided with a convex domed shape for structural strength as well as esthetic considerations. An axially disposed recess 16 may be formed in the top panel to secure a disk 17 bearing graphic indicia such as a logo or attractive artwork.

Extending radially outwardly from the side wall 12 is a lateral flange 18 which forms a skirt 20 (FIG. 9) extending annularly about the mouse device 12. An annular grip member 19 is received about the outer surface of the side wall 12, and is formed from a resilient, tactile material having vertical ridges 21 arrayed thereabout (FIGS. 3, 4, and 6) to enable comfortable manual grasping about the side wall, as will be described below. It is noted that the side wall 12 and grip member 19 together form a vertical grasping surface having a slightly concave configuration. The wall 12 may have the grip portion integrally formed therewith. The base panel 13 is provided with a plurality of gliding feet 22 (also shown in FIG. 9) extending downwardly therefrom, the feet 22 having a minimal height to raise the bottom surface from contact with a mouse-supporting surface. The feet 22 may be integrally formed with the base panel 13, or may comprise individual pads of low friction material, such as PTFE, Delrin®, or the like, secured to the lower surface of the base panel. Although four such feet 22 are shown, a larger or smaller number may be used.

Within the closed housing formed by the base panel 12, side wall 13, and top panel 14, there is disposed a mouse tracking mechanism 26 for generating an electronic signal corresponding to movement of the mouse in the X-Y plane on a mouse-supporting surface. On possible mechanism 26 includes a solid spherical ball 27 disposed within the mouse structure and depending through an axial opening 28 in the base panel 12. The ball impinges on the surface that supports the mouse device, and rolls along the supporting surface as the mouse is moved by the user. A pair of shafts 29 (one shown in FIG. 2) extends horizontally and in mutually perpendicular relationship, each shaft 29 supporting an encoded mask wheel 31 that is engaged at a peripheral portion by an optical sensor 32. Each optical sensor detects rotation of the respective wheel 31, which is caused by impingement and rotation of the ball 27. The sensors 32 thus generate X-Y coordinate translation signals, which are conducted through a cable 33 to a computer or similar electronic appliance. Other mouse tracking mechanisms may be used with equal efficacy in this invention. As is known in the prior art, any such tracking mechanism may be assembled on a common printed circuit board that is mounted within the mouse assembly 11 and disposed adjacent to the ball 27.

The cable 33 includes a distal end connected to an appropriate port of a computer system, and a proximal end that extends through an opening 34 in the top panel 14 to the circuit board of the mouse tracking mechanism. This mounting arrangement causes the cable to be directed upwardly as it extends from the mouse 11, so that the cable 33 describes a semi-loop above the mouse-supporting surface. The loop establishes a slack portion of the cable that exerts no drag or and minimal hindrance of motion of the mouse. Thus the force required to translate the mouse laterally is minimized.

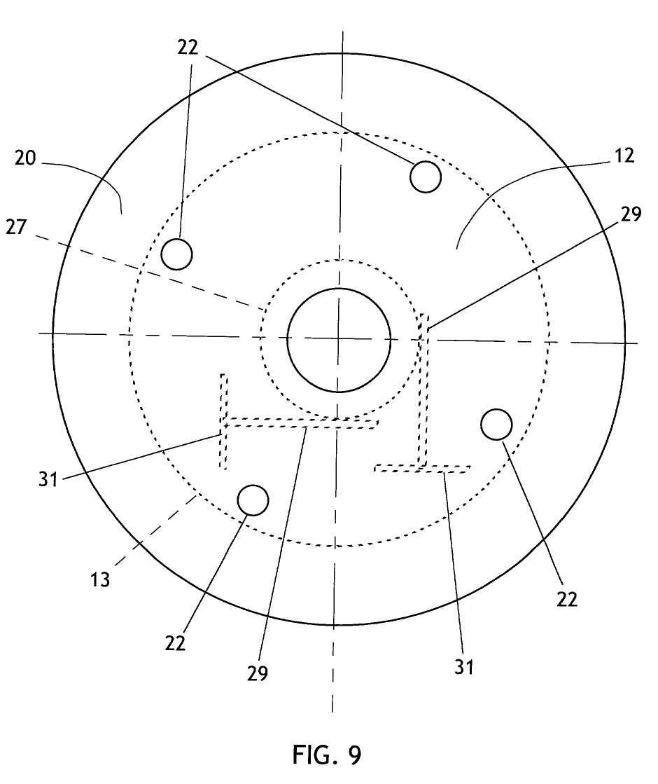

A salient feature of the invention is the provision of convenient user input switches. With reference to FIG. 8, at least one membrane switch 36 is secured at the outer surface of the closed curved side wall 12 and extending circumferentially for a moderate angular increment. Each switch 36 may be disposed beneath the pliable grip member 19, whereby pressure applied to the grip member by the fingers and/or thumb of the user may be transferred to the switch 36. The advantages of this arrangement are enumerated below.

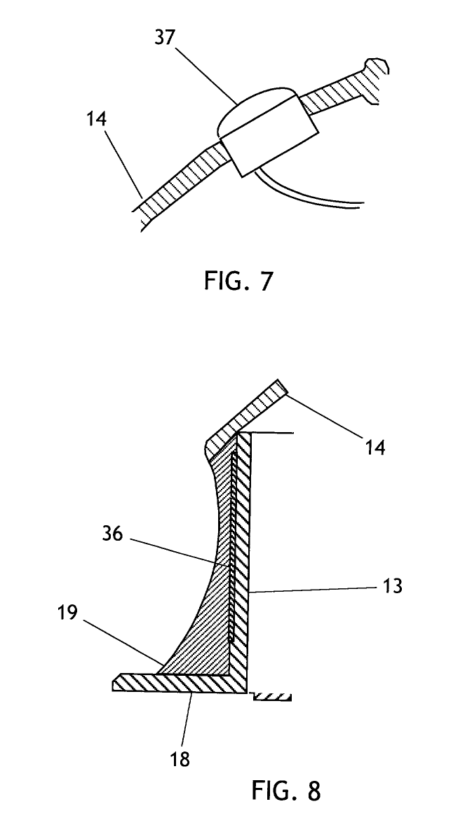

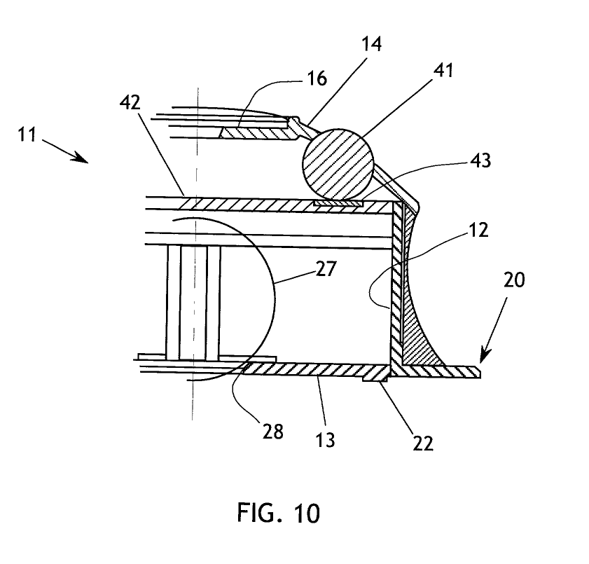

As shown in FIG. 7, the invention may also provide at least one switch 37 supported in the top panel 14 and disposed to be pressed by the index finger of the user, as shown in FIGS. 4 and 6. The switch 37 is also preferably a membrane switch, so that all the switches 36 and 37 may be squeezed to actuate by the digits of the user's hand without requiring any articulation or movement of the fingers. With reference to FIG. 10, an alternative embodiment of the top panel switch includes a small spherical switch ball 41, a small portion of which protrudes through an opening in the top panel 14. A circuit board 42 is supported to extend laterally within the mouse 11, and a membrane switch 43 is secured on the circuit board 42 and positioned to support the switch ball 41. Manual pressure applied to the ball 41 is transferred to the switch 43, which is actuated thereby. The circuit board 42 may also provide support and electronic connections to the mouse tracking mechanism 26 described below, or any other such tracking mechanism.

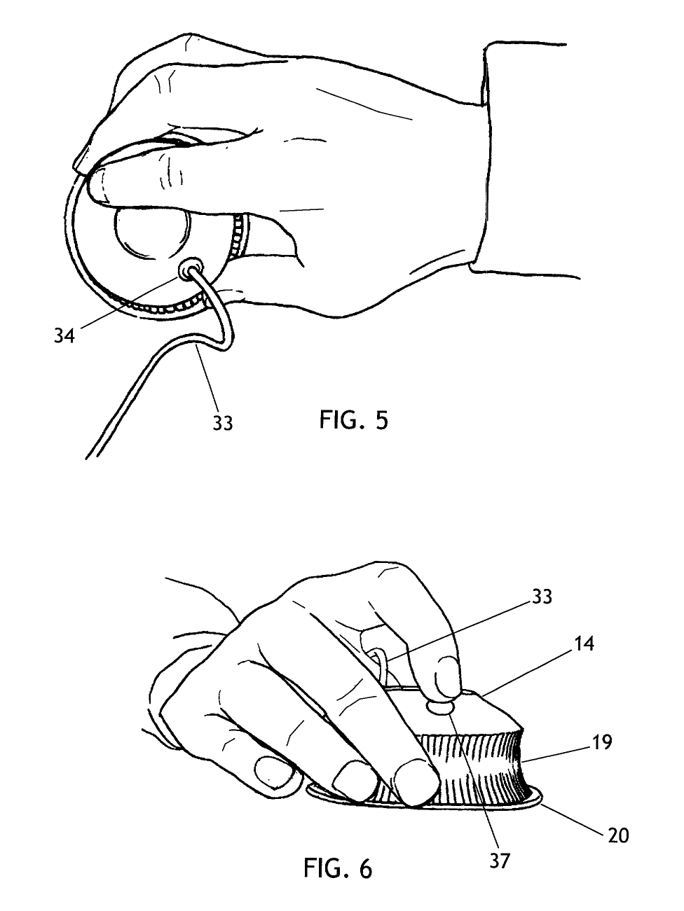

The fingertip mouse 11 is sized so that it may be held comfortably between the thumb and middle finger of the human hand, as shown in FIGS. 4-6. A diameter of 4.5-6 cm accommodates a range of hand sizes while allowing space for switch access aligned with the curve of the index finger. The optimal shape for the oppositionally grasped mouse is circular, allowing the mouse to be rocked or smoothly rotated between the two contact points, but any closed curved shape may be used that is found to be comfortable. The weight of the mouse 11 is between 65-80 grams, well within the exercise range of the musculature of the control digits. This weight can be used comfortably over extended sessions by most users. Drag is reduced in this design by exiting the mouse cable 33 from the top panel 14, and by the elevation of the bottom surface 12 of the mouse 11 from the desktop upon the gliding feet 22, which have a total surface area of approximately 30 sq. mm. Note that the mouse may incorporate wireless transmission circuitry (IR, RF, or the like) and the cable 33 may be eliminated.

An optimal grasping surface is afforded by the continuously curved vertical surface of the grip member 19 contoured by a soft tactilely responsive grip material molded with a slight concavity to accommodate the radius of the fingertips in a comfortable and secure manner. The thin (2 mm) skirt 20 which continues the bottom plane of the mouse radially outwardly to a maximum diameter of 80-85 mm, provides the small, low mass mouse with a stable base. The natural weight of the fingers upon the skirt steadies the mouse, eliminates tipping and prevents inadvertent fingertip drag upon the desktop surface.

A raised tactile ridge 41 (FIG. 2) projects from the top surface of the skirt at the “home” locations of fingertip contact, allows the grasp of the circular mouse to be properly positioned by feel alone, and the switches 36 and 37 are positioned with reference to the ridge 41 so that the fingers are naturally located over the switches. In becoming accustomed to the mouse, the user may also visually locate their grip using switch indicator graphics, such as bright geometric icons, printed on the clear acrylic skirt, and the mouse cable 33, which is in line with the thumb location on the right handed model, and the grasping finger for the left-handed model.

In order to achieve the small cross-sectional size suitable for comfortable grasp by the thumb and middle finger, the mouse controller chip and circuit card typically housed within the palm mouse may be located outside the mouse assembly 11 and placed in any variant of an in-line assembly such as a desktop USB hub or connection box, or simple encapsulation. The mouse 11 preferably contains only the switches 36 and 37, mechanical motion tracking mechanism 26, and encoder stage necessary to produce the electrical signal input to the processor. The controller assembly is located at least twelve inches or more away to permit unimpeded motion of the mouse 11 connected via the flexible shielded cable 33.

This mouse tracking mechanism 26 utilizes finely windowed encoder wheel masks 31 to input motion control pulses to the processor. These masks may be made of circular disks of film on which the light/dark markings are photographically printed. The photographic printing of the encoder mask on the films (Mylar™, acetate, or the like) allows an alternative method to current technology (holes stamped in the plastic encoder wheel,) for achieving fine mask reticules.

The fingertip mouse 11 is designed so that all mouse switches 36 and 37 are accessible without movement of the grasping fingers. The primary switches for the mouse are membrane switches which are flush mounted in the vertical grasping surface and covered by the thin tactically conductive grip of rubber, polymer, plastic, or the like. The location of the switches is found from clearly marked labeling on the skirt 20. The natural grasp of the fingers around the grip allow easy actuation of up to 3 membrane switches. The switches are actuated by grasping or squeezing, not tapping. There is no mechanical “reset” state to these switches as in the case of conventional mechanical mouse switches which makes them smoother and faster to double click. The switches are operated with a very subtle but distinct fingertip pressure that is natural, satisfying and easily learned. The most frequently used switch is designed to lie directly under the primary grasping finger where a “squeeze” action actuates it. A second switch may lie under the ring finger where it also may be actuated by a “squeeze” action. A third switch may be placed (on the right-handed example) adjacent to and approximately slightly clockwise of the second switch, where it may be actuated by either the ring or little finger. The fingertip mouse 11 thereby realizes an approximate 20-25% reduction in carpal tunnel activity over hand-held mouse operation requiring a grasp-independent tapping of its switches. The squeezing action is easily learned and does not inhibit mouse motion.

The mouse 11 includes a 4th membrane switch 37 located in the top panel 14 under the index finger. This ‘button’, of a transparent acrylic material, or the switch ball of the alternative embodiment, may be backlit by LED's within the case. The switch button or ball may be illuminated in response to a command signal from the computer that is connected to the mouse, for a variety of purposes. Further, the use of multi-color LED's enables the switch 37 to change color as a function of mouse switch programming by the mouse controller, or to indicate other computer functions or operations. For example, the switch 37 may serve as an indicator light which is lighted when the mouse is powered, and blinks when any of the switches are actuated. The illumination may be pulsed in accordance with the activity of a game running on the computer, and/or may indicate the success or failure of a game character. The illumination may also be used to indicate computer program functions, such as scrolling, drag-and-drop, file saving, loading, change of program state, program error, email arrival, or the like. Or it may be used to indicate a peripheral device function, such as telephone ringing, printer or scanner operation, or the like. In addition, the illumination may be used to indicate the actuation of the clutch switch function, described below.

The membrane switches provide no tactile or aural “click” as in the case of mechanical switches, and the invention includes software and processor programming which allows the coupling of sounds generated by a computer sound system to the mouse button operation such that immediate aural feedback is provided to the user. The programmable sounds (chimes, clicks, etc) increase the operator's control and general attention to the mouse tasks. This feature is available in the prior art in Macintosh® operating system software and the like.

Additional mouse and computer control is made possible with the design of this invention by identifying at the processor and with software when grip and top buttons are pressed simultaneously in any combination, and translating these events into additional discrete mouse events. It is natural and comfortable to squeeze the grip switches in combinations; i.e., switches 1 and 2, or 1 and 3, as well as in combination with the top switch. The flexibility of this ergo driven combination switch processing is that it allows increased control event generation without additional movement or switches.

Alternatively, the richness of the mouse button programming allows, for instance, switch 1 to be located both in the grip and on the top panel. This mechanical redundancy of the switches translates to the ergonomic advantage of being able to flexibly switch the control actuating tasks between two separate muscle groups to counter fatigue.

The invention further provides a processor-generated function which may be assigned to any of the switches 36 or 37, the effect of which is to uncouple the mouse movement from the cursor positioning task while depressed. This function, herein termed a clutch switch, simply allows the operator to move the mouse while the clutch switch is actuated without moving the cursor on the screen. The ergonomic advantage of the clutch switch is to allow the operator to move the mouse back to the locus of the most comfortable postural position without losing or affecting the cursor position. By allowing the user to return the mouse to this zone or “sweet spot” on the desktop, the user is able to operate the mouse with greatest efficiency and least effort. It is noted that virtually all mouse users have a preferable home position or “sweet spot” where they are most comfortable, and they seek to regain or maintain this position more or less naturally. However, it is inevitable that the mouse tasks will take the mouse out of the zone. Some users even adopt a strategy of lifting the mouse from the desktop (“pawing”) to return it without consequent loss of cursor position, though this action requires a learned skill. The clutch function makes this “homing” strategy available at the touch of a button, and obviates the pawing maneuver.

The foregoing description of the preferred embodiment of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. A computer mouse assembly, including:
a gliding base and a side wall extending upwardly from said base;
said side wall forming a closed curved configuration, said configuration being dimensioned to be grasped between the thumb and opposed fingers of a user's hand;
switch means for receiving user inputs and generating switch click signals;
mouse tracking means disposed within said side wall for generating mouse movement signals; and,
means for transmitting said mouse movement signals and said switch click signals to a computer system.

2. The computer mouse of claim 1, wherein said side wall includes an outer grip surface formed circumferentially thereabout, said outer grip surface extending concavely radially inwardly with respect to the radius of said closed curved configuration.

3. The computer mouse of claim 1, wherein said switch means includes at least one switch secured to said side wall.

4. The computer mouse of claim 3, wherein said at least one switch is disposed beneath one of the grasping fingers of the hand of the user, whereby said at least one switch may be actuated without movement of the finger.

5. The computer mouse of claim 1, further including a top panel spanning an upper opening of said side wall.

6. The computer mouse of claim 5, wherein said switch means includes at least one top switch extending from said top panel.

7. The computer mouse of claim 5, wherein said means for transmitting includes a cable connected from said mouse to a computer system, said cable having a proximal end extending from said top panel, said cable describing a semi-loop above a surface supporting said gliding base to minimize drag on said mouse.

8. The computer mouse of claim 5, wherein said top panel includes an upper surface extending convexly upwardly.

9. The computer mouse of claim 1, further including a flange-like skirt extending radially outwardly, said skirt having a radial extent greater than the radial extent of said closed curved configuration of said side wall.

10. The computer mouse of claim 1, wherein said gliding base includes a base panel extending parallel to the mouse supporting surface, and a plurality of gliding feet extending from said base panel to impinge on the mouse supporting surface.

11. The computer mouse of claim 1, wherein said mouse tracking means includes a central opening in said gliding base, a ball disposed within said side wall, a portion of said ball extending through said central opening to impinge and roll on the mouse supporting surface.

12. The computer mouse of claim 11, said mouse tracking means further including a pair of shafts extending mutually perpendicularly, means for mounting said pair of shafts to contact said ball, said pair of shafts being rotated by said ball as it rolls on the mouse supporting surface, a pair of shaft encoder disks, each mounted on a respective one of said shafts, each encoder disk including a high resolution reticule formed by photographic printing.

13. The computer mouse of claim 6, wherein said at least one top switch comprises a membrane switch.

14. The computer mouse of claim 6, wherein said at least one top switch is lighted internally.

15. The computer mouse of claim 6, wherein said switch means further includes at least one side wall switch secured to an exterior portion of said side wall.

16. The computer mouse of claim 15, wherein said at least one side wall switch is disposed beneath one of the grasping fingers of the hand of the user, whereby said at least one side wall switch may be actuated without movement of the finger.

17. The computer mouse of claim 15, wherein said at least one side wall switch and said at least one top switch are connected in parallel.

18. The computer mouse of claim 15, wherein said side wall includes an outer grip surface formed circumferentially thereabout, said outer grip surface extending concavely radially inwardly with respect to the radius of said closed curved configuration.

19. The computer mouse of claim 18, wherein said at least one side wall switch is disposed beneath said outer grip surface and secured to said closed curved side wall.

20. The computer mouse of claim 19, further including a plurality of said side wall switches mounted in adjacent fashion on said closed curved side wall and disposed to be actuated by the fingers of the user's hand.

21. The computer mouse of claim 6, wherein said at least one top switch includes a switch ball having a portion protruding upwardly through said top panel.

22. The computer mouse of claim 21, further including a membrane switch disposed to receive force transmitted from said switch ball.

23. The computer mouse of claim 22, further including a circuit board disposed within said closed curved side wall, said membrane switch mounted on said circuit board.

24. The computer mouse of claim 14, further including means for selectively illuminating said at least one top switch in response to command signals from a computer connected to said mouse.
